(19) United States
(12) Patent Application Publication
(10) Pub. No.: US 2006/0192843 A1
(43) Pub. Date: Aug. 31, 2006

(54) LED array exposing apparatus and image forming apparatus using the same

(75) Inventor: Tadashi Ohba, Matsuzaka city (JP)

Correspondence Address: ROSSI, KIMMS & McDOWELL LLP., P.O. BOX 826, ASHBURN, VA, 20146-0826, US

(73) Assignee: Kyocera Mita Corporation, Chuo-ku (JP)

(21) Appl. No.: 11/344,521

(22) Filed: Jan. 31, 2006

(30) Foreign Application Priority Data
Jan. 31, 2005 (JP) JAPAN 2005-024281

(51) Int. Cl. B41J 2/45

(52) U.S. Cl. 347/238

(57) ABSTRACT

Provided are an LED-array exposing apparatus and image forming apparatus using the same wherein one or more LED-array chips which mount LEDs corresponding to pixels are employed. LED light intensities are compensated, taking into consideration distance variations between the LED-array chips, a photoreceptor sensitivity and a development bias voltage, thereby reducing an image density variation and black or white longitudinal lines along the photoreceptor rotation direction. The compensation circuit receives image signals and photoreceptor sensitivity, and compensates the light intensities, on the basis of prescribed ligh intensity compensation values and the LED-array chip distances. The compensated image signals together with timing clocks are sent to the LED-array exposing apparatus.

### BACKGROUND OF THE INVENTION

(1) Field of the Invention

The present invention relates to an LED-array exposing apparatus and an image forming apparatus using the same, wherein the density of electro-photographic copies is made as uniform as possible, even when the LED array is deviated from the pixel arrangement, or even when the sensitivities of the photoreceptors per se are varied, or are changed depending upon the temperature.

(2) Description of the Related Art

There are two types of image forming system, i.e., the direct image forming system and the indirect image forming system, for the copiers, printers and facsimiles. The image is directly formed on a sheet of paper in the direct image forming system, while the image is once transferred on an intermediate transfer medium such as the photoreceptor, thereby finally being transferred on the paper. The indirect image forming systems using plain paper are widely employed, except for the home use.

Although an analog image forming process was being used for analog image information in a conventional image forming apparatus such as the copier, a digital image forming process is recently and generally used for digital image information in order to form minute dots on a recording medium. In the digital image forming apparatus, the digital image information of a set of minute dots are exposed on a charged photoreceptor in order to form an electrostatic latent image which is then developed by the toner powder. The toner image is finally transferred on the recording media such as a sheet of paper.

There are laser exposing apparatus and a LED-array exposing apparatus, for exposing on the photoreceptor the digital image information. The laser exposing apparatus scans by the rotational; polygonal mirror the laser beam from the laser diode along the photoreceptor axis direction (the main scan direction), while the LED-array exposing apparatus exposes the photoreceptor by using a linear array of a plurality of the LEDs each of which corresponds to a dot of the digital image. Recently, the LED-array exposing apparatuses are widely used, because they are made smaller-sized, cheaper, easy to control, and highly reliable due to its non-movable structure.

The LED-array exposing apparatus comprises a printed circuit board, an LED-array chip mounted on the printed circuit board, a driving IC for driving the LED-array chip and a lens array of a set of plurality of lenses which are arranged between the photoreceptor and the light emitting surface of the LED-array chip and focus the LED light on the photoreceptor.

One or more LED-array chips are arranged on the printed circuit board (PCB) in order to expose the effective scanning width of the photoreceptor, i.e., the LED-array chip is a light source for forming the electrostatic latent image on the charged photoreceptor. One or more LED-array chips mounting LEDs are linearly arranged. Here, each of the minute LEDs corresponds to minute pixels of the video data to be recorded. For example, LEDs are 5120, for 600 dpi for A4 size recording width.

One or more driving ICs are mounted on the PCB or an exterior of the LED-array chips drive the LEDs in order to emit the lights. The lens array is a bundle of a plurality of rod lenses for focusing the LED lights on the photoreceptor which is exposed by the dots of LED light beams.

However, the light intensity from each LED is varied. Accordingly, the recording quality is degraded in such a manner that the density variation, or longitudinal lines (black or white) along the photoreceptor rotation direction are induced on the developed and fixed image on the recording medium such as the paper. Therefore, the light intensity variation should be compensated by a prescribed light intensity compensation data in such a manner the light intensity from each LED is equalized.

Further, sharp longitudinal lines (white or black) are induced, when the chip distances between the LED-array chips are too greater or smaller, compared with the standard distance. The above-mentioned white or black lines appear remarkably, even when the light intensity variation is suppressed within±2%.

Further, it was found that the density variation becomes remarkable, depending upon the photoreceptor sensitivity. Concretely, the white line becomes remarkable, when the photoreceptor sensitivity is high and the chip distance is greater. On the other hand, the black line becomes remarkable, when the photoreceptor sensitivity is low and the chip distance is smaller. Particularly, the tandem color image forming apparatus is disadvantageously influenced on its color reproducibility, because the tandem color image forming apparatus simultaneously forms different color images by using a plurality of imaging units wherein the photoreceptor is different per color and the density variation becomes different per color if the sensitivity is compensated per color.

Hereupon, various methods are disclosed for preventing the image quality degradation by equalizing the LED light intensity. For, example, JP8-39860A (1996) discloses a light intensity compensation method for the LED print head which comprises the steps of, measuring light intensities at a prescribed driving current for the LEDs, allocating time compensation bits corresponding the light intensities for the LEDs, and calculating exposure energies on the basis of the driving currents and the time compensation bits, thereby obtaining the target energy. Further, JP8-183202A (1996) discloses that the light intensity of the LED print head is compensated by varying the electric currents and the driving times on the basis of LED light intensities and LED to LED distances at the position where the longitudinal white or black lines (along the photoreceptor rotation direction), on such a premise that a test printout is executed beforehand by driving the LEDs by initial data of currents and times.

However, JP8-39860A (1996) has a disadvantage that the light intensity compensation is not rapid, because it takes some time to reach the target intensity. Further, it has another disadvantage that the chip distance variation cannot be reflected on the light intensity compensation.

Further, JP8-183202 (1996) has a disadvantage that the test printout by using the initial LED data is required. Therefore, it takes a long time to correct the light intensity. It has another disadvantage that the exposure level compensation is not perfect, because the compensation is executed only at the portion where the white or black lines are generated.

Furthermore, it is difficult to perfectly suppress the sensitivity variation in or between the production lots. Therefore, JP8-39860A (1996) and JP8-183202 (1996) fails to compensate the light intensity corresponding to the photoreceptor sensitivities.

Furthermore, the photoreceptor sensitivity changes, depending upon the temperature. Therefore, JP8-39860A (1996) and JP8-183202 (1996) fails to compensate the light intensity corresponding to the temperature change of the photoreceptor sensitivity.

### SUMMARY OF THE INVENTION

An object of the present invention is to provide an LED-array exposing apparatus and image forming apparatus using the same which reduces the image density variation and black or white longitudinal lines along the photoreceptor rotation direction.

Concretely, the LED-array exposing apparatus of the first invention comprises: an array of LEDs as light sources; one or more LED-array chips, linearly arranged, for mounting the array of LEDs; a light intensity compensation means LICM for compensating light intensity variation of the LEDs; a lens array for focusing, by using a lens array, light beams from the LEDs; and a photoreceptor exposed by the LEDs each of which corresponds to a dot in image information. In the LED-array exposing apparatus of the present invention, the LICM compensates prescribed standard driving values for the LEDs; by using light intensity compensation data; by using differences between designed distance between the LED-array chips and actual distances between the LED-array chips; and by using sensitivity variation of the photoreceptor and temperature change of the sensitivity of the photoreceptor.

The LED-array exposing apparatus of the second invention may be characterized in that the LICM comprises; memory means for storing the light intensity compensation data, the designed distance and the real distances, the sensitivity variation and the temperature change of the sensitivity of the photoreceptor; and calculation means for calculating the driving values, on the basis of outputs from the memory means.

The LED-array exposing apparatus of the third invention may be characterized in that the LICM compensates prescribed standard driving values for the LEDs by using prescribed light intensity compensation data; the standard driving values are corrected by chip distance compensation coefficients which is decided on the basis of differences between designed distance between the LED-array chips and actual distances between the LED-array chips; the chip distance compensation coefficients are further adjusted by sensitivity variation of the photoreceptor and temperature change of the sensitivity of the photoreceptor.

The LED-array exposing apparatus of the fourth invention may be characterized in that a temperature sensor is further provided. The temperature sensor may be arranged at a position over a paper supply of a print apparatus including the LED-array exposing apparatus, the position being opposite to the LED-array exposing apparatus, across a paper transport means of the print apparatus.

According to the first invention, the LED light intensities are compensated, taking into consideration distance variations between the LED-array chips, a photoreceptor sensitivity and a development bias voltage, thereby reducing an image density variation and black or white longitudinal lines along the photoreceptor rotation direction.

Further, according to the second invention, the light intensity compensation can be easily executed merely by providing memory means for storing the prescribed light intensity compensation data and the distances between the LED-array chips.

Further, according to the third invention, light intensity compensation can be executed more efficiently, because prescribed standard driving values SDVs are compensated by using prescribed light intensity compensation data LICD; SDVs are further corrected by chip distance compensation coefficients CDCCs; and CDCCs are further adjusted by the photoreceptor sensitivity.

Further, according to the forth invention, the temperature data is stably obtained, thereby stabilizing the light intensity compensation.

### BRIEF DESCRIPTION OF THE DRAWINGS

FIG. 1 is a schematic view of the image forming apparatus 2 of the present invention.

FIG. 2 is a plan view of the LED-array exposing apparatus 7 of the present invention.

FIG. 3 is a side view of the LED-array exposing apparatus 7.

FIG. 4 is a block diagram of the LED-array control unit 34 FIG. 5 is a flow chart for compensating the light intensities of the LEDs, on the basis of the photoreceptor sensitivities.

FIG. 6 is a diagram showing weights of the production variation of photoreceptor sensitivities SR at the normal temperature (room temperature) and weights of the temperature change of the photoreceptor sensitivities. The chip distance compensation coefficient is multiplied by those weights. Here, the chip distance is a distance between the LED-array chips.

FIG. 7 a table showing the image density variation after light intensity compensation, when the photoreceptor sensitivity is higher than 250 V.

FIG. 8 a table showing the image density variation after light intensity compensation, when the photoreceptor sensitivity due to the production process is lower than 150 V.

### DESCRIPTION OF THE PREFERRED EMBODIMENTS

The preferred embodiments are explained, referring to the drawings. It should be understood that the present invention is not limited to specifically described sizes, shapes and relative arrangements of the elements.

First, the structure of the image forming apparatus of the present invention is explained.

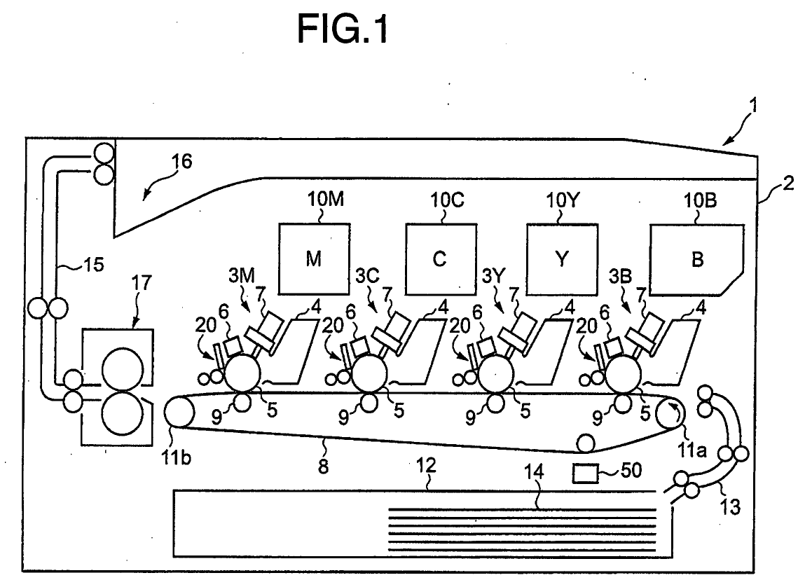

FIG. 1 is a schematic view of the image forming apparatus of the present embodiment.

The image forming apparatus ( an exemplary color printer 1) comprises a body 2, imaging units 3B, 3Y, 3C and 3M for black, yellow, cyan, magenta, respectively, toner hoppers 10B, 10Y, 10C and 10M, a paper supply cassettes 12, a paper supply guide 13, driving rollers 11a and 11b for a transport belt 8, a transfer roller 9, a fixing unit 17, a paper outlet guide 15, a paper outlet 16. Here, each of the imaging units 3B, 3Y, 3C and 3M comprises a developing unit 4, a photoreceptor 5, a main charging unit 6, an LED-array exposing unit 7, a cleaning unit 20.

A temperature sensor 50 arranged in the color printer 1 monitors a temperature of the photoreceptor 5.

Concretely, the temperature sensor 50 is arranged at a position where the temperature changes little, i.e., above the paper supply 16, opposite, across the transport belt 8, to the imaging unit 3B with the LED-array exposing apparatus 7.

Here, the image forming process is briefly explained. A latent image is formed on the photoreceptor 5 which is charged by the main charging unit 6 and is exposed by the LED-array exposing apparatus 7. The latent image is developed by the developing unit 4. Those processes are executed for black, yellow, cyan and magenta. The paper 14 guided by the paper supply guide 13 is chucked on the transport belt 8 which rotates counterclockwise and passes the imaging units 3B, 3Y, 3C and 3M in order to sequentially transfer each color image. Thus, the four color toners forming a full color image on the paper 14 are fixed by the fixing unit 17 and then the paper 14 is guided by the paper outlet guide 15 to the paper outlet 16.

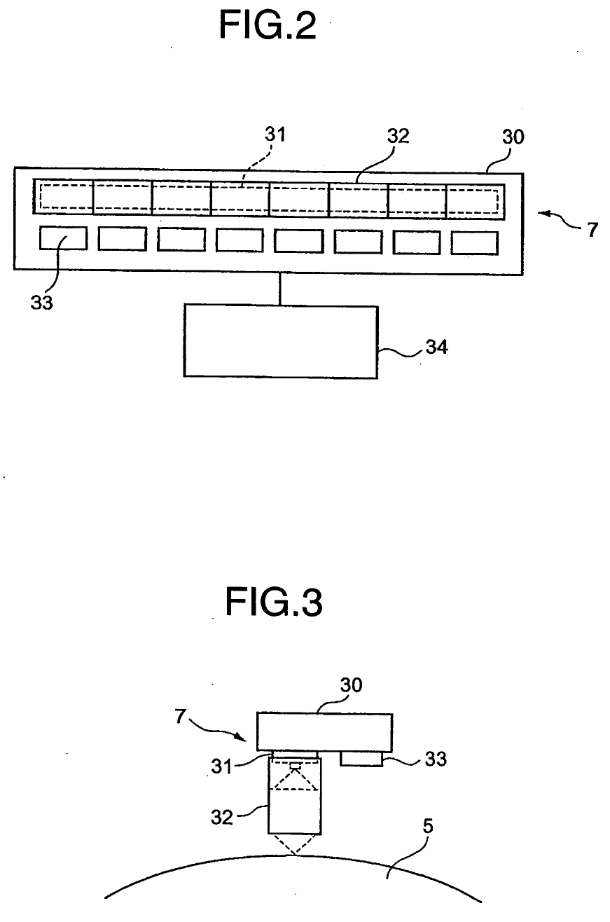

FIG. 2 is a plan view of the LED-array exposing apparatus 7.

The LED-array exposing apparatus 7 comprises: one or more LED-array chips 31 which are linearly arranged on a printed circuit board 30 and includes a plurality of LEDs driven in accordance with image data; a lens array 32 which is arranged over the LED-array chips 31 in order to focus an erecting image with magnification one;

and one or more driving ICs 33 containing driving circuits for driving the LEDs. Here, printed circuit board (PCB) 30 and the lens array 32 are supported by a not-shown supporting member. Further, an LED-array control unit 34 for driving the LED-array exposing apparatus 7 is arranged outside of the LED-array exposing apparatus in the color printer 1.

FIG. 3 is a side view of the LED-array exposing apparatus 7 arranged in the color printer 1.

The lens array 32 focuses the LED lights on the photoreceptor drum 5, as shown by the wave line.

Next, the operation of the image forming apparatus is explained.

Each of the LED is driven in accordance with the image signal transmitted from a not-shown personal computer (PC) arranged outside the color printer 1. Each light from each of the LEDs is focused as a dot, through the lens array 32 on the surface of the photoreceptor 5. As already explained in the related art, in order to compensate the light intensity variation of the LEDs, each exposure energy from each of the LEDs is measured beforehand. Then, the compensation values for the driving currents and/or driving times are calculated by the well-known methods. The calculated compensation values (prescribed compensation data) are stored either in the LED-array control unit 34, in a not-shown control unit of the color printer 1, or in a not-shown memory unit for the LED-array exposing apparatus 7.

Further, the distances between the LED-array chips 31 arranged in the effective scanning width are measured beforehand. The measured distances are stored also either in the LED-array control unit 34, in a not-shown control unit of the color printer 1, or in a not-shown memory unit for the LED-array exposing apparatus 7.

Thus, the image density variation and the longitudinal lines (black or white) along the photoreceptor rotation direction are reduced, on the basis of the compensation values (prescribed compensation data) and the array chip distances, taking into consideration the photoreceptor sensitivity variation and the temperature change of the photoreceptor sensitivity.

Next, the control of the LED-array exposing apparatus 7 is explained.

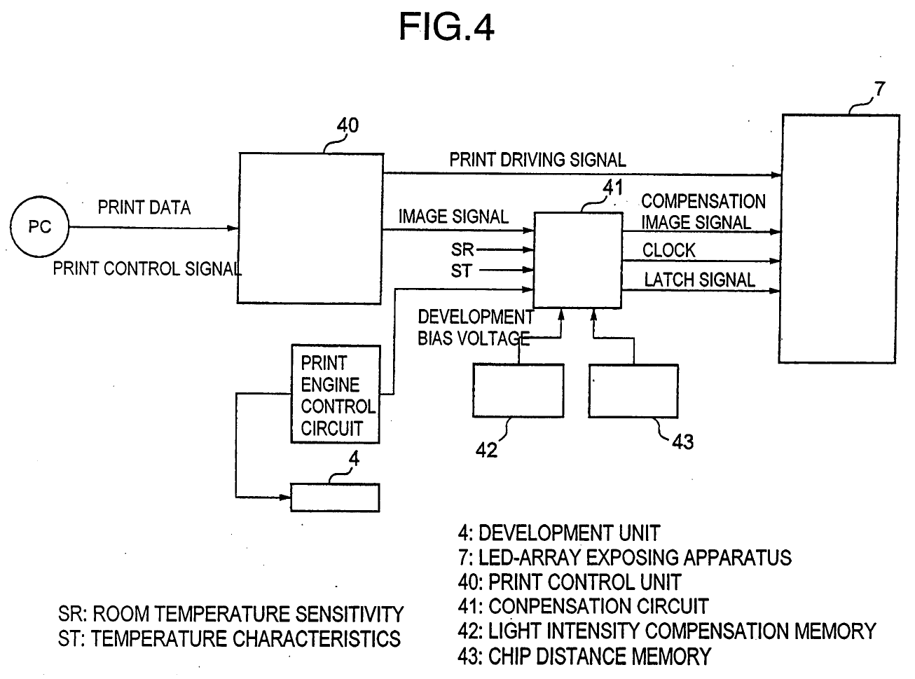

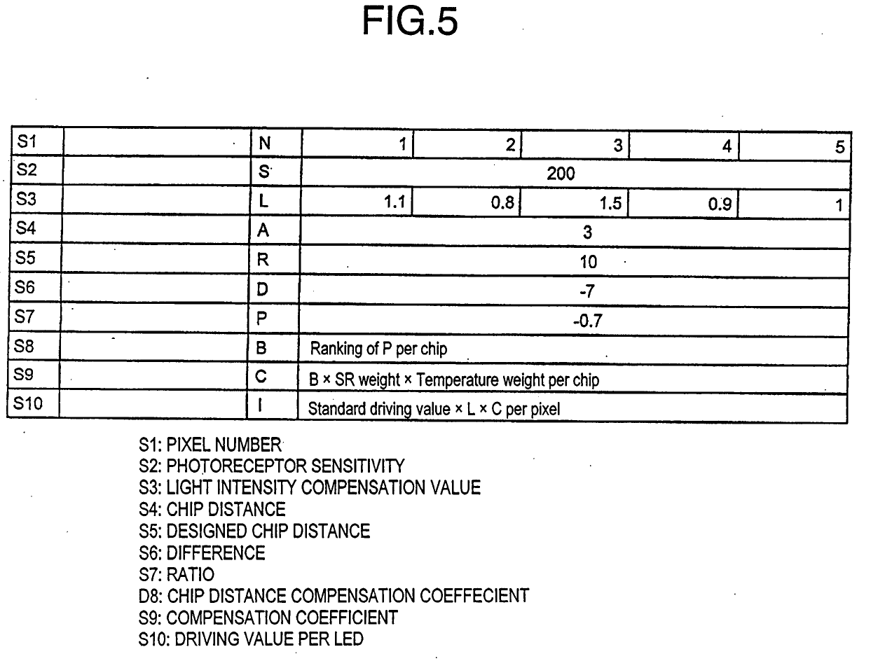

FIG. 4 is a block diagram of the LED-array control unit 34.

The LED-array control unit 34 comprises a ptint control unit 40, a compensation circuit 41 for deciding each light intensity for each pixel. The compensation circuit 41 includes a calculating means for calculating each driving value for each LED. The LED-array control unit 34 further comprises a light intensity compensation value memory 42 for storing the light intensity compensation value, a chip distance memory 43 for storing the distances between the LED-array chips. The LED-array control unit 34 is connected with the LED-array exposing apparatus 7 and is further connected with an external information terminal such as a personal computer PC.

The print data, i.e., the raster signal (pixel signal) is generated by a not shown print driver in the PC and is sent, together with the print control signal, to the print control unit 40 which send a image signal per single scanning line to the compensation circuit 41. The print control unit 40 simultaneously sends the print drive signal to the LED-array exposing apparatus 7, in order to start printing.

The compensation circuit 41 receives the image signal from the print control unit 40 and the room temperature sensitivity SR and the temperature characteristics ST of the sensitivity of the photoreceptor which are prepared beforehand. The compensation circuit 41 further receives the light intensity compensation values (prescribed light intensity compensation data) and the chip distances, from the light intensity compensation value memory 42 and the chip distance memory 43, respectively. Then, the compensation circuit 41 sends compensated image signal for driving the LED together with the timing clock. The compensated image signal is for a single scanning line or a scanning block which is divided from the single scanning line. The latch signal by which the LED-array exposing apparatus 7 lathes the image data for single scanning line or block, thereby simultaneously driving the LEDs.

In this way, in the present embodiment, the light intensity compensations per LED are executed, regarding chip distance, the production variation in the room temperature sensitivity SR and temperature characteristics ST of the photoreceptors.

The image quality degradations such as the density variation and the white or black longitudinal lines are more easily reduced. Here, the sensitivity data SR and ST may be inputted from a not-shown operation unit of the color printer 1, when the photoreceptor is fixed or exchanged. Alternatively, they may be inputted from the not-shown print driver in the PC, by inputting them in the PC.

FIG. 5 is a flow chart of a method for compensating the light intensity of the LEDs in accordance with the photoreceptor sensitivity. For simplicity of explanation, t is assumed that 5 LEDs are mounted on an LED-array chip.

First, at S1, pixels 1 through N to be printed are inputted into the compensation circuit 41. Here, N is 5.

Next, at S2, the room temperature photoreceptor sensitivity SR is read out. The SR shows the production variation of the sensitivity.

Next, at S3, the light intensity compensation value (prescribed light intensity compensation data) L per LED per pixel is read out from the light intensity compensation value memory 42.

Next, at S4, the chip distance A between the LED-array chip to be compensated and the adjacent LED-array chip is read out from the chip distance memory 43.

Next, at S5, the design value R of the chip distance stored in e.g., the chip distance memory 43 is read out.

Next, at S6, the deference D between A and R, i.e., (A−R) is calculated.

Next, at S7, the ratio P (=D/R) is calculated. The LED-array chip distance varies greater, if the absolute value of the ratio P becomes greater.

Next at S8, the compensation ranking is decided in accordance with the ratio P. The coefficient necessary for each rank is empirically decided, thereby calculating a chip distance compensation coefficient B per LED-array chip.

Next, at S9, The coefficient B is further corrected to be a compensation coefficient C which is B multiplied by a weight of SR and a weight of ST.

Finally, at S10, the driving value 1 per LED for each pixel is calculated in such a manner that 1 is equal to the prescribed standard driving value×L×C per pixel.

Here, the flow chart may be executed in such a manner that coefficients B and C are calculated beforehand and stored either in a not-shown control unit of the color printer 1, or in a not-shown memory in the LED-array exposing apparatus 7. In this case, it is not necessary to calculate per exposure the chip distance compensation coefficient B, thereby shortening a time for the compensation.

Next, a method for deciding the compensation coefficient C is explained.

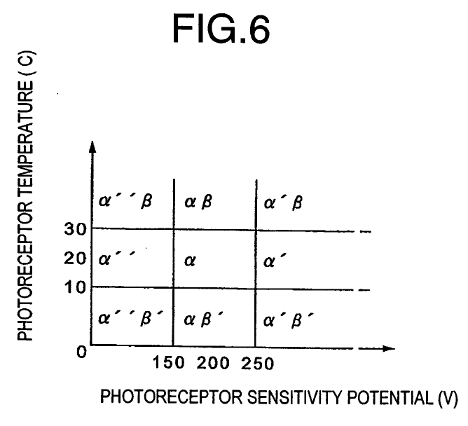

FIG. 6 is an exemplary diagram showing the weights (α, α′, α″) of production variations of the room temperature sensitivities SR of the photoreceptors and the weights (β, β′) of the temperature change of the sensitivity ST.

The SR variations include three regions in term of photoreceptor sensitivity potential such as (lower than 150 V, between 150 V and 250 V, higher than 250 V) which correspond to the weights (α″, α, α′), respectively.

The temperature region include three regions such as (lower than 10° C., between 10° C. and 30° C., higher than 30° C.) which correspond to the weights (β′, 1,, β), respectively.

First, the way how to decide the weights (α″, α, α′) is explained.

The weight of SR is made α as a standard value, when the room temperature sensitivity is between 150 V and 250 V.

Next, if the sensitivity is higher than 250 V, it was found that the white longitudinal lines appear remarkably, when the variation of the chip distance differences D become greater and the chip distances A become greater. Hereupon, the SR weight is made α′ for D=9 μm, or 11 μm, and is made α for D=5 μm, or 7 μm.

On the other hand, if the sensitivity is lower than 150 v, it was found that the black longitudinal lines appear remarkably, as the variation of the chip distance differences D become greater and the chip distances A become narrower. Hereupon, the SR weight is made α″ for D=−9 μm, or −11 μm, and is made α for D=−5 μm, or −7 μm.

Further, the SR weight is made α, when sensitivity is higher than 150 V and the chip distance difference D greater than −9 μm.

Here, the weights (α″, α, α′) are decided empirically beforehand and stored as a lookup table in a not-shown memory in the compensation circuit 41.

Next, the way how to decide the weights (β,β′) is explained.

The weight of ST (temperature change of the photreceptor sensitivity) is made “1” as a standard value, when the temperature is between 10° C. and 30° C.

Next, if the temperature is lower than 10° C., it was found that the white longitudinal lines appear remarkably, when the variation of the chip distance differences D become greater and the chip distances A become greater. Hereupon, the ST weight is made β′ for D=9 μm, or 11 μm, and made “1” for D=5 μm, or 7 μm.

On the other hand, if the temperature is higher than 30° C., it was found that the black longitudinal lines appear remarkably, as the variation of the chip distance differences D become greater and the chip distances A become narrower. Hereupon, the ST weight is made β for D=−9 μm, or −11 μm, and made “1” for D=−5 μm, or −7 μm.

Here, the weights (β, β′) are decided empirically beforehand and stored as a lookup table in a not-shown memory in the compensation circuit 41.

According to the above-explained compensations, the white and black longitudinal lines disappear completely.

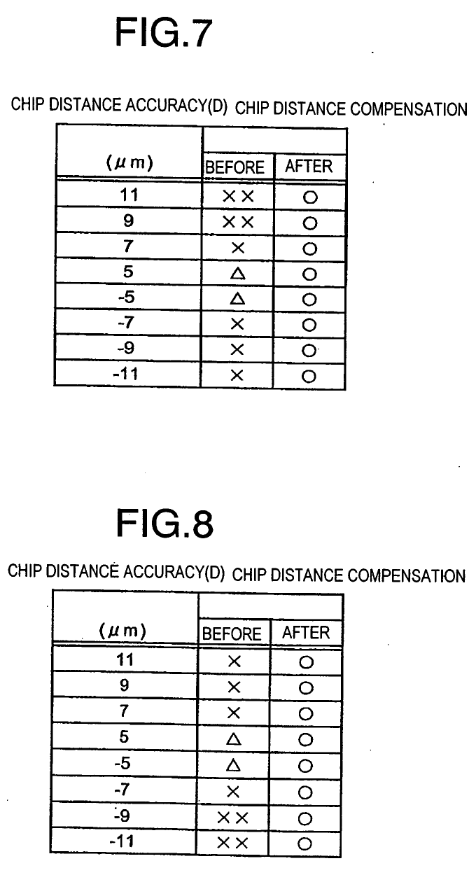

FIG. 7 is a table showing the image density variations before and after the compensation, for a photoreceptor of sensitivity 200 V at the temperature lower than 10° C.

FIG. 8 is a table showing the image density variations before and after the compensation, for a photoreceptor of sensitivity 200 V at the temperature higher than 30° C.

While we have described a preferred embodiment of the present invention, there are several modifications thereof.

For example, the image density and the black or white longitudinal lines are suppressed not only by the above-explained sensitivity compensation, but also by the developing bias voltage Vd. When Vd is lower than 300 V, the white longitudinal lines appear remarkably, as the variation of the chip distance differences D become greater and the chip distances A become greater. Hereupon, the lo compensation coefficient C may be made to be the chip distance compensation coefficient B multiplied by γ′. When Vd is higher than 400 V, the black longitudinal lines appear remarkably, as the variation of the chip distance differences D become greater and the chip distances A become narrower. Hereupon, the compensation coefficient C may be made to be the chip distance compensation coefficient multiplied B by γ″.

Further, in the above-explained preferred embodiment, the chip distance compensation coefficient B and the weighted compensation coefficient C was calculated beforehand and the calculation result was 20 stored in a not-shown control unit in the color printer 1, or in a not-shown memory in the LED-array exposing apparatus 7. Alternatively, the coefficient C may be calculated either by a not-shown control unit in the LED-array exposing apparatus 7, by the LED-array control unit 34 as shown in FIG. 2, or by the not-shown control unit in the color printer 1. The compensation may be executed by calculation processing, or by a integrated circuit including ASIC and so on.

Further, in the above-explained preferred embodiment, the light intensity compensation values and the chip distance data were 30 stored independently in the light intensity compensation memory 42 and chip distance memory 43, respectively. However, they may be stored together in a single memory unit. Further, in the above-explained preferred embodiment, the light intensity compensation values were decided and stored, on the basis of the LED light intensities measured beforehand. However, the light intensity compensation values may be rewritten by using light intensity detecting means for each LED, thereby precisely compensating the light intensity decrease due to possible degradation of the LEDs.

Further, the present invention can be applied not only to the tandem color printer, but also to monochrome digital image forming apparatuses such as copiers, facsimiles, scanners and printers.

What is claimed is:

1. An LED-array exposing apparatus which comprises:
an array of LEDs as light sources;
one or more LED-array chips, linearly arranged, for mounting said array of LEDs;
a light intensity compensation means LICM for compensating light intensity variation of said LEDs;
a lens array for focusing, by using a lens array, light beams from said LEDs; and
a photoreceptor exposed by said LEDs each of which corresponds to a dot in image information,
wherein said LICM compensates prescribed standard driving values for said LEDs;
by using light intensity compensation data;
by using differences between designed distance between said LED-array chips and actual distances between said LED-array chips; and
by using sensitivity variation of said photoreceptor and temperature change of said sensitivity of said photoreceptor.

2. The LED-array exposing apparatus according to claim 1, wherein said LICM comprises;
memory means for storing said light intensity compensation data, said designed distance and said real distances, said sensitivity variation and said temperature change of said sensitivity of said photoreceptor; and
calculation means for calculating said driving values, on the basis of outputs from said memory means.

3. The LED-array exposing apparatus according to claim 1, wherein:
said LICM compensates prescribed standard driving values for said LEDs by using prescribed light intensity compensation data;
said standard driving values are corrected by chip distance compensation coefficients which is decided on the basis of differences between designed distance between said LED-array chips and actual distances between said LED-array chips;
said chip distance compensation coefficients are further adjusted by sensitivity variation of said photoreceptor and temperature change of said sensitivity of said photoreceptor.

4. The LED-array exposing apparatus according to claim 1, which further comprises a temperature sensor which is arranged at a position over a paper supply of a print apparatus including said LED-array exposing apparatus, said position being opposite to said LED-array exposing apparatus, across a paper transport means of said print apparatus.
